(19) United States
(12) Patent Application Publication
(10) Pub. No.: US 2012/0158502 A1
(43) Pub. Date: Jun. 21, 2012

(54) PRIORITIZING ADVERTISEMENTS BASED ON USER ENGAGEMENT

(75) Inventors: WOOK JIN CHUNG, KIRKLAND, WA (US); PRITESH PATWA, REDMOND, WA (US); MARTIN MIROSLAVOV MARKOV, BELLEVUE, WA (US)

(73) Assignee: MICROSOFT CORPORATION, REDMOND, WA (US)

(21) Appl. No.: 12/971,400

(22) Filed: Dec. 17, 2010

(51) Int. Cl. G06Q 30/00

(52) U.S. Cl. 705/14.53; 705/14.66

(57) ABSTRACT

An advertisement engine, a computer-implemented method, and computer-readable media to select advertisements are provided. The advertisement engine is connected to an advertisement database and user database. The advertisement engine selects advertisements from the advertisement database based on user engagement data associated with a user. The user engagement data is stored in the user database. The user engagement data includes the length of time a user focused on content displayed by a client device.

### BACKGROUND

Conventional advertisement platforms provide search advertisements, contextual advertisements, and brand advertisements. The search advertisements are typically provided as part of the search results page. The contextual advertisements are typically provided on webpages that have content similar to the advertisement's content. The brand advertisements are displayed on several webpages associated with one or more internet domains regardless of content on the webpages. An advertiser may select to configure an advertisement campaign on the conventional advertisement platforms to distribute search advertisements, contextual advertisements, or brand advertisements to users.

Conventionally, a user enters a search query in a web browser executing on a user's computer. The search query represents a search intent for the user. The search query entered into the web browser is sent to a search engine. Advertisers bid on the search query to have their search advertisements included in a search results page that is transmitted from the search engine to the user's computer.

Some advertisers may choose to target delivery of the search advertisement to users based on gender, time of day, or location. Advertisers that have bid the highest will have optimal placement of their advertisements on the search results page that the search engine sends to the user's web browser. For example, Jim's Pizza may be an advertiser in “Bellevue, Wash.,” that only wants to show its advertisements to users who are searching for local information around Bellevue. When a user submits a search query in the web browser for “Bellevue, Wash.,” to the search engine, a results page that includes the advertisement for Jim's Pizza may be returned to the web browser. If Jim's Pizza was the highest bidding advertiser, the advertisement for Jim's Pizza would receive optimal placement. If Jim's Pizza was not the highest bidding advertiser, the advertisement for Jim's Pizza would receive suboptimal placement.

In some situations, targeting will be ineffective because the search query generated by the user may consist of keywords that have not been bid on by an advertiser or the user profile information is not consistent with current interests of the user.

### SUMMARY

Embodiments of the invention include computer-readable media, methods, and advertisement engine that manage and select advertisements that are presented to a user.

The advertisement engine is communicatively connected to client devices, a user database, and advertisement database. The user database is configured to store user profiles that include interests of users that interact with content. The advertisement database is configured to store advertisements and targeting information provided by advertisers.

The advertisement engine is configured to deliver advertisements to client devices of users interacting with content. The advertisement engine receives user engagement data from the client devices that render the content that the users interact with. The advertisement engine updates the user profiles with keywords included in the user engagement data. In turn, the advertisement engine selects advertisements from the advertisement database based on the interests of the users that interact with the content and the keywords. The advertisement engine prioritizes the selected advertisements. The advertisement engine transmits the prioritized advertisements for rendering on the client device.

This Summary is provided to introduce a selection of concepts in a simplified form that are further described below in the Detailed Description. This Summary is not intended to identify key features or essential features of the claimed subject matter, nor is it intended to be used as an aid in isolation in determining the scope of the claimed subject matter.

### BRIEF DESCRIPTION OF THE DRAWINGS

FIG. 1 illustrates an exemplary computing environment for managing and selecting advertisements, according to embodiments of the invention;

FIG. 2 illustrates an exemplary client device according to embodiments of the invention;

FIG. 3 illustrates an exemplary graph of estimated demand for attentive users of the client device, according to embodiments of the invention; and

FIG. 4 illustrates an exemplary logic diagram of a method that selects advertisements based on user engagement data, according to embodiments of the invention.

### DETAILED DESCRIPTION

This patent describes the subject matter for patenting with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described. Further, embodiments are described in detail below with reference to the attached drawing figures, which are incorporated in their entirety by reference herein.

Embodiments of the invention leverage post-delivery user engagement with content and advertisements to refine selection of subsequent advertisements that are transmitted to the user. In some embodiments, the user engagement data includes a level associated with the user engagement with content. In turn, the user engagement data is exposed to advertisers to allow targeting based on the measured levels of engagement. In one embodiment, videos of the user are processed to track a users eyes and identify keywords in the content that the user is reading. The identified keywords are used to select additional advertisements that are displayed to the user. Additionally, the identified keywords may be stored in a user database and associated with the user that interacted with the content.

Alternatively, the focus of the user may be determined from gestures, pointer selections, touch selections, etc. The content may be a webpage having various sections. The identified keywords may be extracted from the section of the webpage that the user focuses on.

In another embodiment, the advertisers may target advertisements based on the level of user engagement or the identified keywords stored in the user database. The advertiser may specify bids that vary as a function of the level of user engagement. Alternatively, the advertiser may include advertisements that vary as a function of the level of user engagement. Thus, the advertisement platform may utilize the level of user engagement to rank advertisements selected for delivery to the user.

In certain embodiments, the user engagement data includes a length of time a user has interacted with a webpage. A video of the user reading a webpage may be processed to identify the length of time the user focused on the content of the webpage and interacted with the webpage. The video may be analyzed to identify other individuals near to the user or a user's current environment. For instance, the computer system may examine the video to identify multiple individuals near to the user interacting with the content. The computer system may also detect the user's environment, e.g., work, home, café, etc. The number of users and the user's current environment may be utilized to determine a level of user engagement with the webpage. If someone is close to the user, the user engagement data may be discounted because of the likelihood for distraction. If the user is at a busy café, the user engagement data may also be discounted because of the likelihood for distraction. The distractions may include, but not limited to, moving away from the computer, or switching to a different window on the computer, an individual speaking with the user, etc. The length of time a user is not interacting with the webpage may be used to discount the length of time.

In other embodiments, the distractions are determined from, among other user generated events, mouse movements, keyboard strokes, gestures, or scroll behavior captured by the computer system. The captured mouse movements, keyboard strokes, gestures, or scroll behavior are analyzed to determine whether the user is interacting with the website and to determine a length of time that has surpassed since the user initiated interaction with the website. The captured mouse movements, keyboard strokes, gestures, scroll behavior, or other user generate events are an indicator of whether the user is actually viewing the website as opposed to doing something else.

A computer system for managing and selecting advertisements includes client devices communicatively connected to a search engine and advertisement engine. The client devices generate search terms provided by users of the client devices and transmit the search terms to the search engine. The search engine receives the user search terms and communicates with an advertisement engine to select advertisements based on user engagement data associated with the user.

As one skilled in the art will appreciate, the computer system includes hardware, software, or a combination of hardware and software. The hardware includes processors and memories configured to execute instructions stored in the memories. In one embodiment, the memories include computer-readable media that store a computer-program product having computer-useable instructions for a computer-implemented method. Computer-readable media include both volatile and nonvolatile media, removable and nonremovable media, and media readable by a database, a switch, and various other network devices. Network switches, routers, and related components are conventional in nature, as are means of communicating with the same. By way of example, and not limitation, computer-readable media comprise computer-storage media and communications media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read only memory (ROM), electrically erasable programmable read only memory (EEPROM), flash memory or other memory technology, compact-disc read only memory (CD-ROM), digital versatile discs (DVD), holographic media or other optical disc storage, magnetic cassettes, magnetic tape, magnetic disk storage, and other magnetic storage devices. These memory components can store data momentarily, temporarily, or permanently.

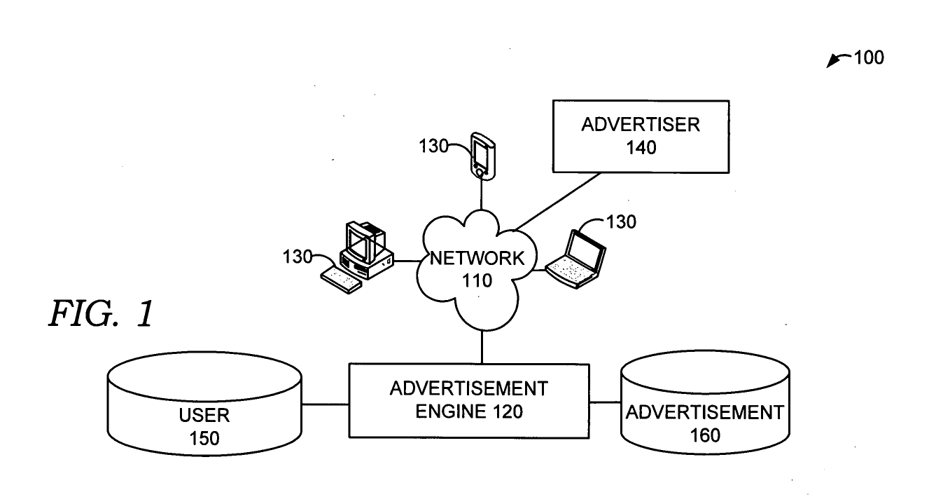

FIG. 1 illustrates an exemplary computing environment for managing and selecting advertisements, according to embodiments of the invention. The computing environment 100 includes a network 110, an advertisement engine 120, client devices 130, an advertiser 140, user database 150, and an advertisement database 160.

The network 110 is configured to facilitate communication between the client devices 130 and the advertisement engine 120. The network 110 also facilitates communication between the advertisement engine 120 and the advertiser 140. The network 110 may be a communication network, such as a wireless network, local area network, wired network, or the Internet. In an embodiment, the client devices 130 may communicate user engagement data to the advertisement engine 120 utilizing the network 110. In response, the advertisement engine 120 may provide advertisements that are selected based on user engagement data for the users of the client devices 130.

The advertisement engine 120 selects the advertisements that are transmitted via network 110 to the client devices 130. In turn, the client devices 130 display the advertisements to the users. The advertisers 140 transmit targeting information to the advertisement engine 120. The targeting information includes desired length of time a user focused on the content, time of day, gender, location, income, and other demographic information for the audience targeted by the advertisers 140. In some embodiments, the targeting information may specify that certain criteria are required and other criteria are optional. For instance, an advertiser 140 may indicate that location criteria, Seattle, is a required criteria but time of day, afternoon, is an optional criteria. Also, the advertisement engine 120 receives advertiser bids. The advertiser bids specify an amount an advertiser is willing to pay to have its advertisement selected by the advertisement engine 120 and transmitted to a client device 130 for rendering when the advertisers' targeting information is satisfied. In certain embodiments, the advertiser bids may be raised or lowered based on the number of targeting criteria satisfied by the users of the client device that will receive the advertisement. In one embodiment, the advertiser bids vary as function of the desired length of time a user focused on the content. For instance, a camera advertiser may want to provide a large bid when the user has focused on content discussing photography principles. The same camera advertiser may chose a medium bid when the user has entered a search term “camera” in the search and spends a short length of time focusing on the received search results for camera. In yet another embodiment, the advertisers 140 provide the advertisement engine 120 with multiple advertisements, where the advertisements vary as a function of the satisfied targeting criteria. The advertisement engine 120 stores the advertisements and targeting information in the advertisement database 160.

In some embodiments, the advertisement engine 120 is configured to identify the level of interest a user has in one or more categories. The identified level of interest may be subject matter expert, professional, amateur, or beginner. The advertisement engine may utilize the user engagement data to determine, among other things, a category associated with content the user engages with and a length of time the user focused on the content. The category may include shopping, sports, finance, electronics, clothes, etc. The category may be determined by performing a dominant phrase analysis on the content. For instance, the content may be an article discussing a sports team discussing player statistics, coaching principles, and player injuries. Accordingly, the advertisement engine 120 may categorize the article as a sports article. In turn, the advertisement engine identifies a level of interest based on the complexity of the article, the length of time the user focused on the article, and the frequency that the user reviews articles in the category. A user that focuses on sports articles using a computer during the weekend in the fall may be categorized as an amateur. The advertisement engine 120 may select fan attire or memorabilia advertisements from sport team advertisers for display to the user when the user is reading the sports articles on the client device 130.

The client devices 130 are utilized by users to generate search terms and to receive results having advertisements that are relevant to the search terms. The client devices 130 also render content that the users are interested in. The client devices 130 may be used to capture user engagement data. Videos of the users interacting with the content are processed to determine a length of time the users engaged with the content and the portions of the content that the users engaged with. Alternatively, pointer selections, voice commands, gestures, or other user inputs may be utilized to identify a region of the content that the users are focusing on. The client devices 130 may provide the user engagement data, including the length of time the users engaged with the content and the portions of the content to the advertisement engine 120 over the communication network 110. In turn, the advertisement engine 120 delivers advertisements to the users based on the user engagement data. In some embodiments, the users' interactions, videos, gestures, and pointer selections are processed by the client devices 130 to determine the user engagement data. In other embodiments, the client devices 130 transmit the user interactions to the advertisement engine 120, which processes the user interactions to determine the user engagement data and then delivers appropriate advertisements to the users.

The client devices 130 include, without limitation, personal digital assistants, smart phones, laptops, personal computers, gaming devices, or any other suitable client computing device. In some embodiments, the client devices 130 include image capture and voice capture devices. The image capture devices include cameras, video cameras, etc. The voice capture devices include microphones, recorders, etc. The client devices 130 include a user and system information storage to store user and system information on the client device. The user information may include search histories, cookies, user identifiers, online activities, user engagement data, and passwords. The system information may include Internet protocol addresses, cached webpages, and system utilization. In other embodiments, the client devices 130 are large screen displays. The large screen displays may be utilized by an advertiser to display a first advertisement to the user. The first advertisement may include a picture of a shoe with a description associated with the shoe. The large screen display may include a camera that captures a user's engagement with the advertisement. When the video of the user captured by camera indicates that the user has focused on the advertisement more than a threshold period, the large screen display is updated with additional advertisements associated with shoe included in the first advertisement. Accordingly, the additional advertisements may include the shoe and professional athletes that endorse the shoe.

The advertisers 140 provide targeting information, keywords, bids for keywords, bids for targeting data, and advertisements to the advertisement engine 120. The targeting information, keywords, bids for keywords, bids for targeting data, and advertisements are stored in the advertisement database 160. The advertisers 140 promote goods or services with the advertisements. The advertisements may include search advertisements, contextual advertisements, and display advertisements provided by the advertisers 140. The search advertisements are advertisements that are displayed with search results. The contextual advertisements are advertisements that are displayed with contextually relevant webpages. The display advertisements are displayed with an associated webpage regardless of context or keywords. The keywords provided by the advertisers 140 are associated with the search advertisements and contextual advertisements. The keywords are utilized to select search advertisements having keywords that match query terms included in the search results displayed to the user. The keywords are utilized to select contextual advertisements having keywords that match terms included in the content of the webpage viewed by the user. The targeting data may be utilized to select display advertisements having targeting data that match data extracted from a webpage being viewed by the user or data extracted from the client device utilized by the user to view the webpage.

In other embodiments, the advertisers 140 may opt-in to parameter targeting provided by the advertisement engine 120. The parameter targeting allows the advertisers 140 to vary a maximum bid for keywords received by the advertisement engine 120. In one embodiment, advertisers 140 may select the desired length of time a user engages with content to receive the advertisements stored in the advertisement database 160 associated with display time period similar to the desired length of time a user engages with content. The advertisers 140 may vary the display time period such as long (e.g., greater than 20 seconds), medium (e.g., between 10 and 20 seconds), or short (e.g., less than 10 seconds). Optionally, the advertiser 140 may select a level of user interest, e.g., beginner, engaged, neutral, not engaged, or the category assigned to the content focused on by the user.

In some embodiments, advertisers 140 may tag the advertisements with category or display time period. The tags may be utilized by the advertisement engine 120 to select the appropriate advertisement. Each advertiser 140 may provide several advertisements having varying display time periods. Also, the advertisers may include advertisements tagged with different categories. In one embodiment, the categories may include keywords extracted from content previously displayed to the users that focused on the content in the selected category. For instance, an advertiser 140 may upload three advertisements of the same product. Each advertisement may be tagged by the advertiser 140. The first advertisement may be tagged as long. The second advertisement may be tagged as medium. And the third advertisement may be tagged as short. The advertisement engine 120 will select an appropriate version of the advertisement based on the length of time the user previously spent on content in the current category. Alternatively, the advertisement engine 120 may gradually shift from advertisements tagged with a short display period when the length of time the user has focused on the content is short, and if the user continues focusing on the content past the short period, the advertisements tagged with medium are selected for display, and so forth.

The user database 150 stores user engagement data for the users of the client devices 130. The user database 150 may be stored locally on the client device 130 or remotely in a separate storage location on the network 110. The user engagement data is associated with user identifiers and include timestamps that indicate when the user engagement data was captured by the client devices 130 of the users.

The advertisement database 160 stores advertisements. The advertisement database 160 also stores the keywords, targeting information, and bids associated with each advertisement. In some embodiments, the advertisements are banner advertisements, display advertisements, text, images, contextual advertisements, search advertisements, audio advertisements, or mobile advertisements that describe a good, service, or thing that an advertiser wishes to promote to users. The things described in the advertisements may include events and items from all over the world, from various merchants, and from various distributors. The advertisements are selected by the advertisement engine 120 and delivered to the client devices 130 based on user engagement data and monetization values derived from the selected advertisements.

One of ordinary skill in the art understands and appreciates that the computing environment 100 has been simplified for description purposes and alternate operating environments are within the scope and spirit of this description.

In certain embodiments, a client device monitors user interaction with content. The client device may process the user interaction to generate user engagement data. An advertisement engine may receive the user engagement data from the client device. In turn, the user engagement data is utilized to select advertisements for rendering on the client device.

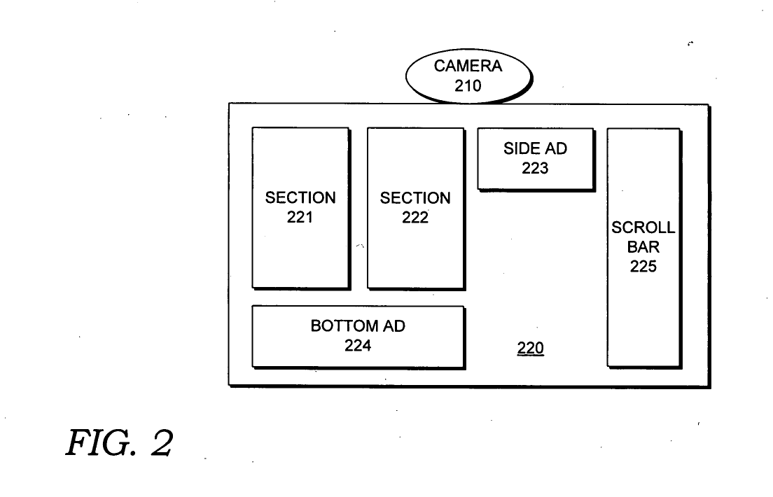

FIG. 2 illustrates an exemplary client device 220 according to embodiments of the invention. The client device 220 displays content to a user. In some embodiments the client device 220 may include a camera 210 that is external to the client device. Alternatively, the camera 210 may be integrated into the client device 220. In one embodiment, the content may be an article with multiple sections 221, 222. The client device 220 may render a display having the content and advertisement placeholders: side ad 223 and bottom ad 224.

The camera 210 generates a video that tracks the eyes of the users interacting with content. Content having multiple sections 221, 222 or content displayed on large display devices may include sections 221, 222 of the content that the user is unable to view during an initial view of the content. Based on eye-gaze analysis and additional processing of the video, the client device 220 may determine the sections 221 and 222 of the content users focused on. The client device 220 may determine coordinates of the display area a user is focused on at any given point of time. The coordinates are mapped to the content displayed on the client device 220 to determine the precise portions of the content focused on by the user. In turn, keywords may be extracted from the portions of the content focused on by the user and included in the user engagement data. In some embodiments, small display devices may allow the user to view all of the content at the same time. On a small display device, the user may double tap with a pointer or finger, gesture a zoom-in command, or select a zoom-in function to enlarge a section 221 or 222 of the content. The keywords may be extracted from the section 221 or 222 of the content focused on by the user and included in the user engagement data. Alternatively, on a small display device, a scrolling up or down gesture or selection of the scroll bar 225 may be utilized by the user to move to a section 221 or 222 of interest to the user. The vertical coordinates may be extracted from the content and utilized to extract keywords from the section 221 or 222 currently viewed by the user. The extracted keywords are stored in the user engagement data to select an appropriate advertisement for display to the user.

For example, ACME news provides content on a webpage that is rendered on a client device. ACME news has approximately 100 million views per day, which may lead to at least 100 million impressions for advertisements. Ready InsuranceCo, is an advertiser that purchased the right to display its display advertisements on ACME news' webpage for a specified period of time for each different user that views the content. ACME news' webpage may include sections 221 and 222 with two headline news articles, eight subarticles (not shown), side ad 223 and bottom ad 224. The first headline news article in section 221 may be “Olympic Games in China.” The second headline news article in section 222 may be “Real Estate News in Kansas City, Mo.” A user that visits ACME news' webpage may receive Ready InsuranceCo's display advertisement. When the user continues interacting with ACME news' webpage the advertising engine determines whether the user is reading the “Olympic Games in China” article or the “Real Estate News in Kansas City, Mo.” article. The advertising engine may utilize the camera, mouse, vertical positions, or user engagement data to determine the portion of section 221 or 222 that the user is reading. The advertisement engine may determine that the user is reading “Olympic Games in China” article. Based on the keywords extracted from the article that the advertising engine determined that the user is interacting with, the advertising engine may update side ad 223 with contextual advertisements related to China or the Olympic Games and replace Ready InsuranceCo's display advertisement. Alternatively, Ready InsuranceCo's display advertisement may be moved by the advertisement engine to bottom ad 224 and side ad 223 may be updated with contextual advertisements related to China or the Olympic games provided by advertiser TravelCo. Later, the advertisement engine may determine that the user is reading “Real Estate News in Kansas City, Mo.” article. Based on the keywords extracted from the article, the advertising engine may update side ad 223 with contextual advertisements related to banks or financial management and replace Ready InsuranceCo's display advertisement. Alternatively, Ready InsuranceCo's display advertisement may be moved by the advertisement engine to bottom ad 224 and side ad 223 may be updated with contextual advertisements related to banks or financial management provided by advertiser FinanceCo.

The advertisers Ready InsuranceCo, FinanceCo, and TravelCo, may pay for placement or categories. Ready InsuranceCo, FinanceCo, and TravelCo target users that read articles on ACME news' webpage. Ready InsuranceCo may have targeted a specific category of content displayed on the webpage and provided only display advertisements. FinanceCo and TravelCo may have targeted specific categories and provided contextual advertisements. FinanceCo may have targeted finance content. TravelCo may have targeted travel content. In one embodiment, ACME news may receive some royalty for allowing the advertisers to target the content interacted with by its users.

In some embodiments, if a user has spent more time focused on section 221 than section 222, keywords are extracted from section 221 and those extracted keywords may be utilized by the advertisement engine to select advertisements for display in the advertisement placeholders: side ad 223 and bottom ad 224. Alternatively, the client device 220 may generate user engagement data for each section 221 and 222 when the user focuses on that section 221 or 222. In turn, the client device 220 extracts keywords from the section 221 or 222 currently focused on by the user to select advertisements for display in the advertisement placeholders: side ad 223 and bottom ad 224. In some embodiments, the bottom ad 224 may not be displayed until the user repositions the content with the scroll bar 225. Thus, the advertisement selected for bottom ad 224 by the advertisement engine may be based on keywords in the portion of the content focused on by the user after the content is repositioned.

Accordingly, embodiments of the invention select advertisements based on user engagement generated from user interaction with content displayed on the client device 220. Interests of the user may be identified using keywords that are included in the portion of the content focused on by the user. The advertisement placeholders may be updated with additional advertisements as the length of time a user focused on the content increases.

In some embodiments, an advertisement engine may receive increased revenues as users focus on content. The additional revenue may be generated by delivering an appropriately tailored advertisement to the user that is consistent with the current interest of the user. Moreover, advertisers may save funds by focusing delivery of advertisements to users with interest in the category of products available from the advertiser.

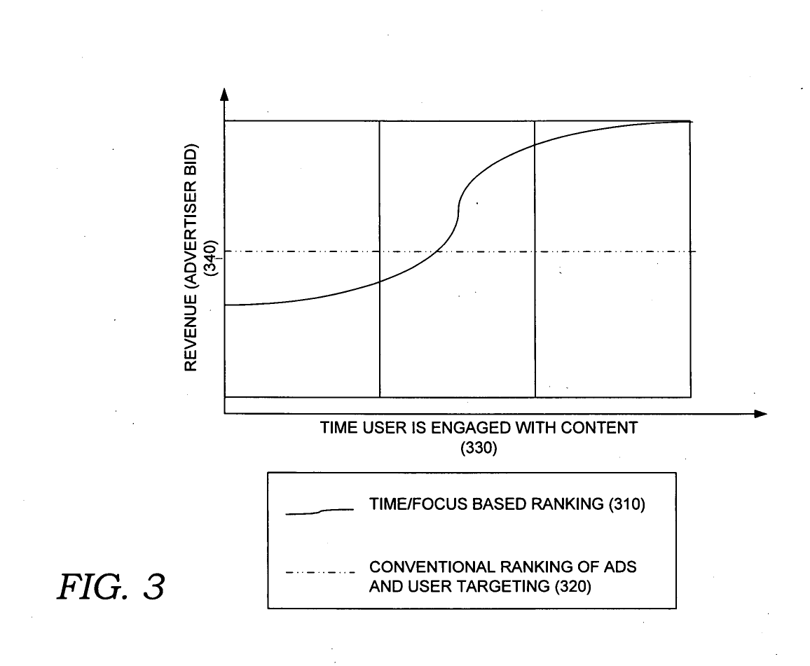

FIG. 3 illustrates an exemplary graph of estimated demand for attentive users of the client device, according to embodiments of the invention. The graph 310 illustrates advertisers' willingness to pay additional revenue for users that focus on the content displayed by the client devices. The graph 310 also reflects a potential ranking for attentive users. The graph 320 shows the demand in a conventional bidding system that do not measure the length of time 330 metric utilized by the advertisement engine in the embodiments of the invention. In the conventional bidding system, the advertiser bid 340 remains the same regardless of how long 330 a user is focused on the content. Thus, an opportunity to target the users focused on content discussing topics in a category similar to products or goods offered by the advertiser may be lost in the conventional bidding system.

For instance, a user may search for a branded electronic device, e.g.,

“SurePhoto camera.” A search engine may return results including SurePhoto camera and other cameras, including BestImage camera. SurePhoto Inc. may be an advertiser that developed an advertising campaign on the advertisement engine. BestImage Inc. may be another advertiser that developed an advertising campaign on the advertising engine. In SurePhoto's advertising campaign, SurePhoto Inc. bids low on keywords with its brand SurePhoto when the length of time a user has focused on the content is low. But SurePhoto Inc. may bid more on keywords with its brand SurePhoto when the length of time a user has focused on the content is medium or high. In BestImage's advertising campaign, BestImage Inc. may bid high on keywords having camera when the length of time a user has focused on the content is low. In some embodiments, BestImage Inc. also bids high when the length of time a user has focused on content having keywords that are related to its competitors is low. BestImage Inc. may enter the high bid because it wants to capture the user's attention before the user becomes engaged with content from a competitor, e.g., SurePhoto Inc. If the user types, “SurePhoto,” BestImage Inc. may enter a high bid while the length of time of user engagement with content associated with “SurePhoto” is low. BestImage Inc.'s high bid may provide an opportunity to capture the attention of a user that has expressed an interest in images or photography via the search term “SurePhoto.” However, if the length of time of user engagement with content associated with “SurePhoto” passes a threshold or is high, BestImage Inc. may lower its bid because the user appears to be interested only in SurePhoto Inc.'s images or photography. Also, BestImage Inc. may bid lower for the keywords having camera when the length of time a user has focused on the content is medium or high. In turn, the advertisement engine selects the advertisements based on the advertiser bids as the length of user engagement with the search results increases or the length of user engagement with content increases.

In another embodiment, an advertisement engine selects advertisements based on user engagement data having keywords included in a portion of content focused on by the user. The keywords are extracted from the portion of the content focused on by the user and transmitted to the advertisement engine. In turn, the advertisement engine selects an advertisement associated with keyword or a category related to the keyword from the advertisement database and delivers the advertisement to the user.

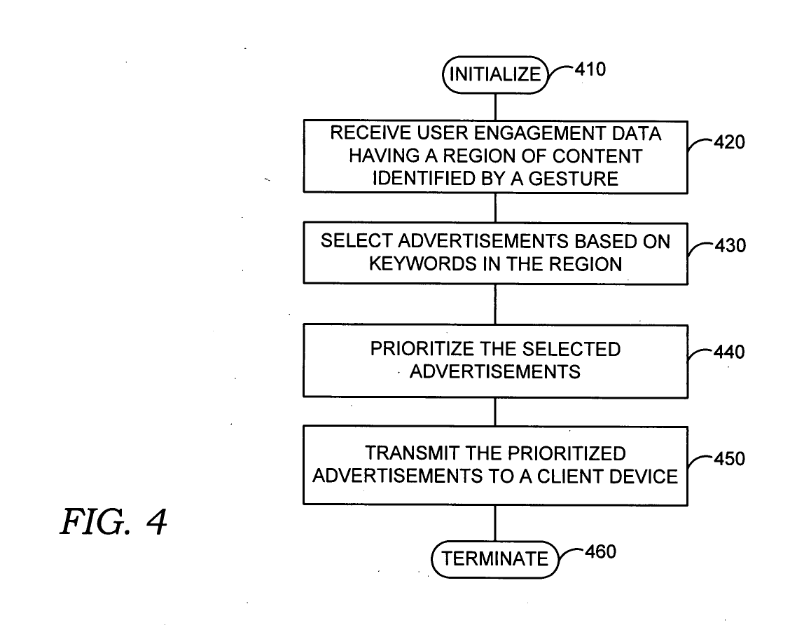

FIG. 4 illustrates an exemplary logic diagram of a method that selects advertisements based on user engagement data, according to embodiments of the invention. The advertisement engine may include one or more computer-readable media storing instructions that configure a processor to perform a method to select advertisements. The method to select advertisements is initialized at step 410, when the advertisement engine is powered on. At step 420, the advertisement engine may receive user engagement data, wherein the user engagement data comprises a region of content identified by a gesture. The gesture may be any one of a zoom-in, select, or highlight of a region of the content action received by the client devices. The gesture may also include eye movement, e.g., left to right or up to down, etc. In one embodiment, the user engagement data further comprises a length of time a user has interacted with the region. The length of time may be determined from measurements of one or more cameras that monitor eye movements of the user.

In turn, the advertisement engine may select one or more advertisements for delivery based on keywords included in the region identified by the gesture, at step 430. Optionally, the advertisement engine may also match a time period associated with one or more advertisements stored in an advertisement database with the length of time the user has interacted with the region of the content to select the one or more advertisements.

At step 440, the advertisement engine prioritizes the one or more selected advertisements. The advertisements may be prioritized based on advertiser bids that vary as a function of the length of time. The one or more prioritized advertisements are transmitted to the client device for rendering with the content, at step 450. The method may iterate several times as the user continues interacting with different portions of the content and additional user engagement data is provided to the advertisement engine by the client device. In some embodiments, the user engagement data is archived to create a history for the user. The history may be utilized by the advertisement engine to determine whether the user is an enthusiast, professional, amateur, rookie, novice, etc. For instance, if the user is engaged with gaming related sites for a significant period of time each week, the advertising engine may update a profile associated with the user to indicate that the user is a video game enthusiast. The profile information and user engagement data are utilized by the advertisement engine to prioritize advertisements that are relevant to the interests of the user stored in the use profile and user engagement data. Accordingly, the advertisers are able to target a user's proficiency, e.g., enthusiast, professional, amateur, rookie, novice, etc. The advertisers may also provide the advertisement engine with advertisements that vary as a function of proficiency. The method terminates in step 460.

In summary, computer-implemented methods, computer-readable media, and advertisement engines that manage and select advertisements are provided. The advertisement engines are configured to receive and store user engagement data that is utilized to select advertisements for delivery to the user. In some embodiments, the user engagement is stored in the user database to assign a level of interest to the user for various categories of content that the user focuses on. In one embodiment, content subscribed to by the user may be utilized to influence the assigned user level. A user subscribing to sports news may be assigned an amateur level in the user database. In turn, the advertisement engine may select advertisements targeted to amateurs for display to the users assigned an amateur level. Alternatively, the advertisement engine may select advertisements having a tag, provided by the advertisers, indicating that the advertisement should be delivered only to amateurs.

In certain embodiments, the advertisement engine allows the advertisers to target keywords included in the user engagement data. For instance, the advertisement engine may show advertisers the keywords extracted from content that the user focuses on for a long period of time. In some embodiments, the extracted keywords are grouped into categories, and the categories are exposed to advertisers. Thus advertisers may tag advertisements submitted with the advertisements with the extracted keywords or the categories that are relevant to the product or services promoted by their advertisements.

In other embodiments, the advertisers may target the length of time a user has focused on the content. The user engagement data includes the length of time the user has focused on the content and a reference or copy of the content or the portion of content focused on by the user is also stored in the user database. The advertisement engine may expose the varying lengths of time users focused on content of a specific category and allow the advertisers to bid based on varying lengths of time for the specific category for content similar to the categories associated with products or services promoted by their advertisements. In other embodiments, the advertisers may tag advertisements with a display period that is within a length of time that a user focused on the content for the category of interest to the advertiser. In turn, the advertisement engine may utilize the display period to select advertisements for display to a user that previously focused on the content for a specific length of time or to a user that is currently focusing on the content for a specific length of time.

In yet another embodiment, an advertisement engine is configured to deliver advertisements to a user's client device based on the user engagement data. The advertisement engine provides, via an advertisement database, access to one or more advertisements and a time period associated with the one or more advertisements. In turn, the advertisement engine receives user engagement data, wherein the user engagement data specifies a length of time a user has interacted with a type of content previously rendered by a client device similar to content currently rendered by the client device. The user engagement data may include a region of the content currently rendered that interests the user determined by measurements of one or more cameras that monitor eye movements of the user. In some embodiments, the user engagement data comprises keywords extracted from the region. The extracted keywords may be stored in a user database having a profile associated with the user.

The advertisement engine selects one or more advertisements for delivery based on the length of time the user has interacted with the type of content previously rendered by the content device. In one embodiment, the advertisement engine matches the time period associated with the one or more advertisements with the length of time the user has interacted with the type of content previously rendered similar to the content currently rendered by the client device to select the one or more advertisements. Alternatively, the advertisement engine matches the time period associated with the one or more advertisements with a length of time the user has interacted with a region of the content previously rendered having a type similar to a region of content currently rendered by the client device.

The advertisement engine also prioritizes the one or more selected advertisements that match the content currently rendered by the client device. The one or more prioritized advertisements are transmitted to the client device for rendering.

The foregoing descriptions of the embodiments of the invention are illustrative, and modifications in configuration and implementation will occur to persons skilled in the art. For instance, while the embodiments of the invention have generally been described with relation to FIGS. 1-4, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the embodiments of the invention are accordingly intended to be limited only by the following claims.

We claim:

1. A computer-implemented method to deliver advertisements to a user's client device, the method comprising:
providing one or more advertisements and a time period associated with the one or more advertisements;
receiving user engagement data, wherein the user engagement data specifies a length of time a user has interacted with a type of content previously rendered by a client device similar to content currently rendered by the client device;
selecting one or more advertisements for delivery based on the length of time the user has interacted with the type of content previously rendered by the client device;
prioritizing the one or more selected advertisements that match the content currently rendered by the client device; and
transmitting the one or more prioritized advertisements to the client device for rendering.

2. The computer-implemented method of claim 1, wherein selecting one or more advertisements further comprises matching the time period associated with the one or more advertisements with the length of time the user has interacted with the type of content previously rendered similar to the content currently rendered by the client device.

3. The computer-implemented method of claim 1, wherein selecting one or more advertisements further comprises matching the time period associated with the one or more advertisements with a length of time the user has interacted with a region of the content previously rendered having a type similar to a region of content currently rendered by the client device.

4. The computer-implemented method of claim 1, wherein the user engagement data further comprises a region of the content currently rendering those interests the user determined by measurements of one or more cameras that monitor eye movements of the user.

5. The computer-implemented method of claim 4, wherein the user engagement data comprises keywords extracted from the region.

6. The computer-implemented method of claim 4, further comprising extracting keywords from the region.

7. The computer-implemented method of claim 6, further comprising storing the keywords in a profile associated with the user.

8. A computer system, the system comprising:
a user database configured to store user profiles that include interests of users that interact with content;
an advertisement database configured to store advertisements and targeting information provided by advertisers; and
an advertisement engine configured to deliver advertisements to users interacting with content, wherein the advertisement engine:
receives user engagement data from client devices that render the content that users interact with,
updates the user profiles with keywords included in the user engagement data,
selects advertisements from the advertisement database based on the interests of the users that interact with the content and the keywords,
prioritizes the selected advertisements, and
transmits the prioritized advertisements for rendering on the client device.

9. The computer system of claim 8, wherein the advertisements are prioritized based on advertiser bid amount.

10. The computer system of claim 9, wherein the advertisement database also stores for each advertisement, multiple advertiser bid amounts that vary as a function of the length of time that users interact with the content.

11. The computer system of claim 8, wherein the advertisement database stores advertisements that are assigned a display period.

12. The computer system of claim 8, wherein the keywords included in the user engagement data are extracted from a region of the content that was focused on by the user.

13. The computer system of claim 12, wherein the user focus is determined by one of: cameras tracking a user's eyes, gestures, zoom-in actions, highlight actions, pointer movements, scrolling actions, or voice commands.

14. The computer system of claim 8, wherein the user profiles specify a level of interest for topics included in the profiles.

15. The computer system of claim 14, wherein the level of interest is one of: subject matter expert, professional, amateur, or beginner.

16. A computer-readable media storing computer-usable instructions for performing a method to deliver advertisements to client devices, the method comprising:
receiving user engagement data, wherein the user engagement data comprises a region of content identified by a gesture;
selecting one or more advertisements for delivery based on keywords included in the region identified by the gesture;
prioritizing the one or more selected advertisements; and
transmitting the one or more prioritized advertisements to the client device for rendering with the content.

17. The computer readable media of claim 16, wherein the user engagement data further comprises a length of time a user has interacted with the region, the length of time is determined from measurements of one or more cameras that monitor eye movements of the user.

18. The computer-readable media of claim 17, wherein selecting one or more advertisements further comprises matching a time period associated with one or more advertisements stored in an advertisement database with the length of time the user has interacted with the region of the content.

19. The computer-readable media of claim 17, wherein the advertisements are prioritized based on advertiser bids that vary as a function of the length of time.

20. The computer-readable media of claim 16, wherein the gesture is one of: a zoom-in, select, or highlight of a region of the content action received by the client devices.
